(19) United States
(12) Patent Application Publication
(10) Pub. No.: US 2025/0298625 A1
(43) Pub. Date: Sep. 25, 2025

(54) FAST BOOT OF A HOST SYSTEM CONNECTED TO A PERIPHERAL DEVICE

(71) Applicant: MICRON TECHNOLOGY, INC., Boise, ID (US)

(72) Inventors: Gaurav Sinha, Unterschleißheim (DE); Marco Redaelli, Munich (DE)

(21) Appl. No.: 19/069,872

(22) Filed: Mar. 4, 2025

Related U.S. Application Data
(60) Provisional application No. 63/567,792, filed on Mar. 20, 2024.

(51) Int. Cl. G06F 9/4401

(52) U.S. Cl. CPC G06F 9/4411

(57) ABSTRACT

A system can include a memory device; and a processing device, operatively coupled with the memory device, to perform operations including: receiving, from a host system connected to the memory device, a first reset signal; determining whether a first value stored in a configuration space of the memory device indicates a fast boot; responsive to determining that the first value indicates the fast boot, loading a fast boot firmware from the memory device, wherein the fast boot firmware allows the processing device to access a boot partition of the memory device; and responsive to receiving a request from the host system, retrieving boot data from the boot partition.

### RELATED APPLICATIONS

This application claims the benefit of U.S. Provisional Patent Application No. 63/567,792, filed Mar. 20, 2024, the entire contents of which are incorporated by reference herein.

### TECHNICAL FIELD

Embodiments of the disclosure relate generally to memory sub-systems, and more specifically, relate to fast boot of a host system connected to a peripheral device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of an example system for implementing fast boot of a host system connected to a peripheral component interconnect express (PCIe) device in accordance with some embodiments of the present disclosure.

FIGS. 3-5 are flow diagrams of example methods for implementing fast boot of a host system connected to a peripheral component interconnect express (PCIe) device in accordance with some embodiments of the present disclosure.

FIG. 6 is a block diagram of an example computer system in which embodiments of the present disclosure may operate.

### DETAILED DESCRIPTION

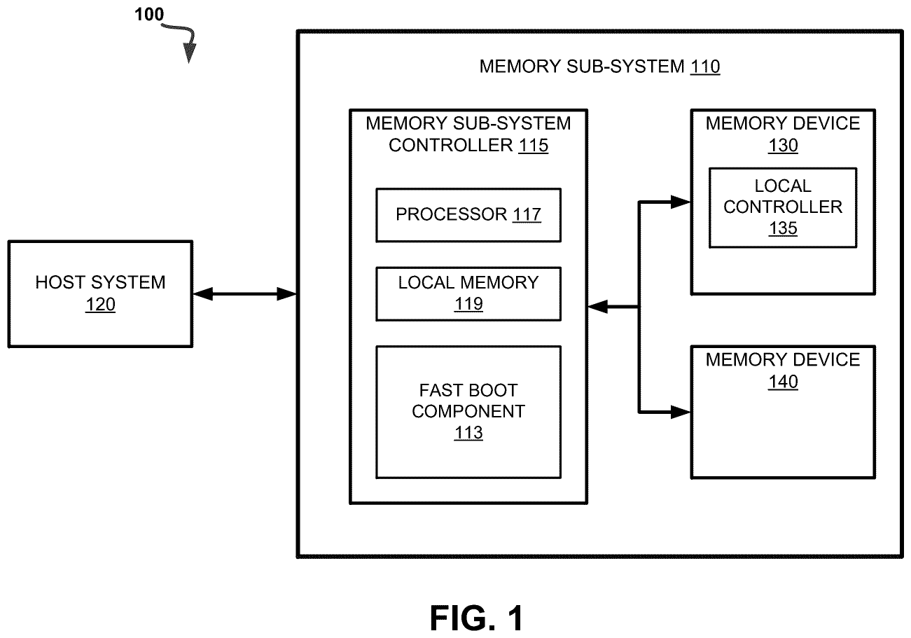

Aspects of the present disclosure are directed to fast boot of a host system connected to a peripheral device. A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A peripheral device can be connected to a host system, where the operating system in the host system can support various applications running on the host system and communicate with the peripheral device. For example, the peripheral device can be a peripheral component interconnect express (PCIe) device that is connected to the host system through the PCIe link for communication, including, for example, graphics adapter cards, network interface cards (NICs), storage accelerator devices, and other high-performance peripherals. In some computing systems, an application (e.g., automotive application) running on the host system demands a fast boot of the host system. One method for the fast boot of the host system may use the boot partition and optimized physical layer, and the boot partition and optimized physical layer can be provided by flash memory, such as a negative-or (NOR) drive or a managed negative-and (NAND) drive. In some PCIe devices that include the flash memory and another memory, such as a solid-state drive (SSD), the system tends to use the flash memory as the boot device and uses the SSD as secondary storage.

For example, in certain memory sub-systems that employ a memory controller (which includes a processing device and embedded memory), the controller performs a boot using boot firmware such as a basic input/output system (BIOS) or the newer Unified Extensible Firmware Interface (UEFI). In general, motherboards (e.g., that may include the controller and other memory sub-system components) support BIOS/UEFI boot firmware, but modern motherboards tend to use flash memory for storing boot firmware. For example, serial peripheral interface (SPI) NOT-OR (or SPI-NOR) flash drives have become a common choice (particularly in automotive and industrial applications) for storing the boot firmware because of reliability and because that SPI-NOR devices do not need to first copy the boot firmware to random access memory (RAM), typically static RAM (SRAM), to be able to execute the boot firmware. Although the SSD may also support boot partition, accessing the boot partition from the SSD would take longer than accessing the boot firmware stored on the traditionally used flash memory (e.g., NOR drive or managed NAND drive). As such, a boot would still be performed using the flash memory, instead of the SSD. There is a need of a fast boot mechanism that uses an SSD, instead of the flash memory, as a boot device.

Aspects of the present disclosure address the above and other deficiencies by implementing a fast boot capability in a device (e.g., an extended capability of a PCIe device) by using a new configuration space register to define boot configurations. The new configuration space register enables the fast boot of an operation system of the host system from a memory that is not traditionally used for booting, where the memory (e.g., SSD) is included in the device (e.g., PCIe device) connected to the host system, and the device may or may not include the flash memory that is traditionally used for booting.

Specifically, the new configuration space register is configured in the device (e.g., PCIe device) and may include a field to indicate a fast boot or a normal boot (referred to as “boot field”). For example, the value indicating a fast boot (e.g., bit value 1) and/or the value indicating a normal boot (e.g., bit value 0) may be pre-defined during manufacturing. When the boot field has a value indicating a fast boot, the new configuration space register may include another field that defines parameters of fast boot (e.g., parameters of the communication link between the device and the host system that include a reduced link width (e.g., minimum number of PCIe lanes) and/or a reduced link speed (e.g., minimum data rate)). When the boot field has a value indicating a normal boot, the parameters of a normal boot, which is defined as the normal usage case and can be stored in the new configuration space register or other places, may be used and may include parameters of the communication link for a maximum link width (e.g., maximum number of PCIe lanes) and/or a maximum link speed (e.g., maximum data rate). In some cases, the default value of the boot field may be preset to indicate a fast boot such that when the boot field is checked for the first time, a fast boot is to be used.

As an illustrative example, the host system may detect a power-on event occurred on the host system and the PCIe device and then send a reset signal to the PCIe device. The reset signal may ensure that PCIe device is properly reset and configured to establish a stable communication link to the host system. Upon receiving the reset signal, a controller of the PCIe device may determine whether a value of the boot field equals the value indicating a fast boot. Responsive to determining that the value of the field equals the value indicating the fast boot, the controller of the PCIe device may load a fast boot firmware and perform a first training of PCIe lanes of the PCIe link between the PCIe device and host system. The fast boot firmware is minimized in size as a boot firmware and can be quickly loaded by the controller and executed to provide this minimal support for booting. For example, the fast boot may enable access to a boot partition of the memory in the PCIe device before the controller has full operational access to the memory in the PCIe device. The first training of PCIe lanes uses parameters of the fast boot, which includes a reduced link speed (e.g., minimum data rate) and/or a reduced link width (e.g., minimum number of PCIe lanes). Upon loading and training, the controller of the PCIe device may access first boot data that is used for a fast boot from a designated storage area (e.g., a boot partition stored in a non-volatile memory) of the PCIe device and send the first boot data to the host system for initiating a fast boot. The first boot data is used to provide a partial operational state of an operating system of the host system.

After completing the fast boot, the host system may send, to the PCIe device, a command requesting a normal boot. For example, the command may request to set the boot field described above to a value indicating a normal boot. The host system may then send another reset signal to the PCIe device. Upon receiving the reset signal, the controller of the PCIe device may determine whether the value of the boot field equals the value indicating a fast boot. Responsive to determining that the value of the field does not equal the value indicating the fast boot, the controller of the PCIe device may load a normal boot firmware and perform a second training of PCIe lanes of the PCIe link between the PCIe device and host system. The normal boot firmware can be loaded by the controller and executed to provide full operational access to the memory in the PCIe device. The second training of PCIe lanes uses parameters of the normal boot, which may include an increased link speed (e.g., maximum data rate) and/or an increased link width (e.g., maximum number of PCIe lanes). Upon loading and training, the controller of the PCIe device may access second boot data that is used for a normal boot and send the second boot data to the host system for initiating a normal boot. The second boot data is used to provide a full operational state of the operating system of the host system.

Upon completing the normal boot, the boot field may be set back to a value indicating a fast boot. For example, the host system may send a field-resetting command requesting to reset the boot field to a value indicating a fast boot, and the controller of the PCIe device may set the boot field according to the field-resetting command. As another example, the boot field may be preset as a value that can be changed only when the power supply is on but will be returned to a default value when the power supply is off, and as such, when the PCIe device is power off, the value of the boot field is returned to the default value indicating a fast boot.

Advantages of the present disclosure include but are not limited to enabling a fast boot for a PCIe device that includes a non-volatile memory (e.g., SSD), without the need of using traditionally used flash drive (e.g., NOR drive or managed NAND drive) for a fast boot. This can result in reduced boot time and better cost efficiency due to no need for a separate flash drive. Aspects of the present disclosure can be applied to various PCIe devices, including not only memory devices, but also graphics adapter cards, network interface cards (NICs), storage accelerator devices, and/or other high-performance peripherals. Further, automotive and embedded applications with fast boot requirements can use PCIe SSD, instead of relying on flash drives, for fast boot.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units (MUs).

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processors.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

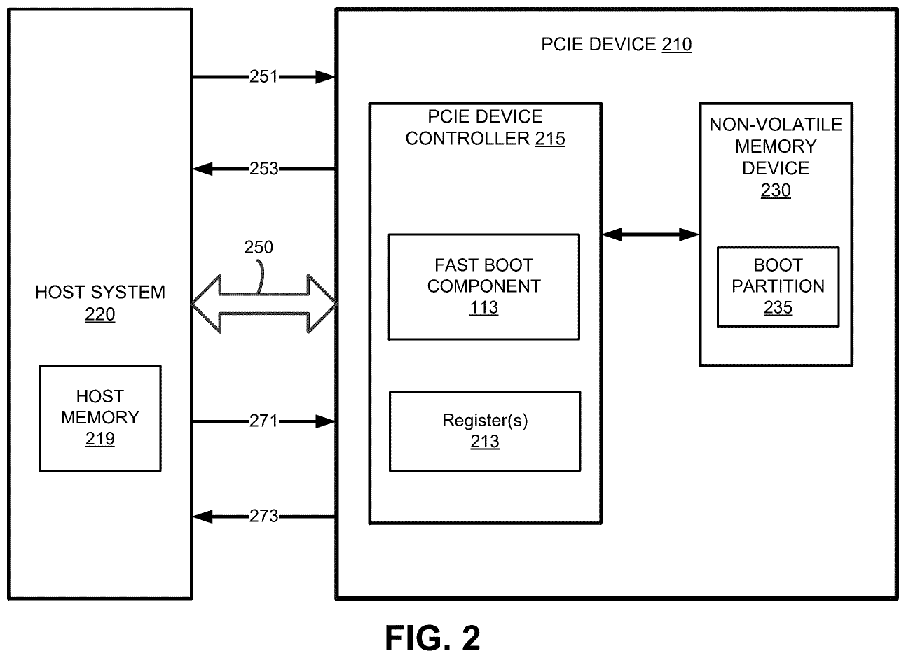

In some embodiments, the memory sub-system 110 includes a fast boot component 113. In some embodiments, the memory sub-system controller 115 includes at least a portion of the fast boot component 113. In some embodiments, the fast boot component 113 is part of the host system 110, an application, or an operating system. In other embodiments, local media controller 135 includes at least a portion of fast boot component 113 and is configured to perform the functionality described herein. Further details regarding the operations of the fast boot component 113 are described below with reference to FIGS. 2-6.

It will be appreciated by those skilled in the art that additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

A more detailed depiction of an embodiment of the present disclosure that is shown in FIG. 2 includes an example memory sub-system 110 and can be understood with continued reference to FIG. 1. As shown in FIG. 2, the memory sub-system 110 may be a PCIe device 210, and the PCIe device 210 may connect to a host system 220 (e.g., the host system 120) via a PCIe link 250. The PCIe device 210 can include the PCIe device controller 215 (e.g., sub-system controller 115) that includes the fast boot component 113 and one or more registers 213, and a non-volatile memory device 230 (e.g., SSD).

The PCIe device 210 may be one or more of graphics adapter cards, network interface cards (NICs), storage accelerator devices, and/or other high-performance peripherals. In some implementations, the PCIe device 210 may include a configuration space that includes one or more registers 213. The register 213 may include a boot field used to indicate whether a fast boot or a normal boot is to be used. For example, the boot field may use a flag bit to indicate the fast boot (e.g., value 1) or the normal boot (e.g., value 0). In some implementations, the register 213 may include one or more fields representing parameters of the fast boot. For example, the parameters of the fast boot may include a first data rate representing a reduced link speed (e.g., a minimum link speed), or a first number of PCIe lanes representing a reduced link width (e.g., a minimum link width). In some implementations, the register 213 may include one or more fields representing parameters of the normal boot. For example, the parameters of the normal boot may include a second data rate representing an increased link speed (e.g., a maximum link speed), or a second number of PCIe lanes representing an increased link width (e.g., a maximum link width).

One or more fields of the register 213 described above may be set to initial values during the manufacture of the PCIe device 210. For example, the initial value of the boot field may be set as a flag bit to indicate the fast boot (e.g., value 1). In some implementations, the host system 220 may re-configure one or more fields of the register 213 during the operation of the PCIe device 210. For example, the host system 220 may change the initial value of the boot field to a flag bit to indicate the fast boot (e.g., value 1) and/or change it back to a flag bit to indicate the normal boot (e.g., value 0).

The host system 220 can determine an occurrence of a power-on event by determining whether a power state metric (e.g., a value of a parameter of a power supply measured at a component of the host system) satisfies a threshold criterion. The power-on event may represent power supply from off to on state or re-activating from sleep state. For example, the host system 220 may monitor the power state metric and compare the power state metric to a threshold criterion in order to determine whether power-on event occurs. In some embodiments, the host system 220 can determine whether a voltage or a change in voltage at an interface or an input/output pin of the host system 220 satisfies a threshold criterion (e.g., falling below or rising above a predetermined value). In some embodiments, the host system 220 can detect a rapid change in the voltages (e.g., at the interface or the input/output pin) over a short period of time.

In response to determining an occurrence of a power-on event, the host system 220 can send to the PCIe device 210 a reset signal 251. The reset signal (e.g., PERST) may trigger a PCIe enumeration process and provide a hardware-level reset mechanism used to reset and initialize the PCIe device 210. The reset signal may ensure that PCIe device 210 is properly reset and configured to establish a stable communication link to the host system 220, including the necessary training and negotiation processes required for reliable data communication. The PCIe device 210 may perform the operation of resetting according to the reset signal. In some implementations, the resetting process can be referred to as a hardware initialization phase, in which the firmware, often stored in a read-only memory (ROM) chip, performs a series of self-tests and hardware checks to ensure proper functionality. For example, the controller 215 may retrieve a read-only memory (ROM) code from an internal ROM of the controller 215, and execute the ROM code to load the boot code (or bootstrap code) from the memory device 230 into the embedded volatile memory (e.g., the local memory 119). The boot code (or bootstrap code) is configured to initialize hardware of the PCIe device.

In some implementations, the fast boot component 113 may determine whether a first value stored in the register 213 of the PCIe device 210 indicates a fast boot. For example, “1” is pre-defined to indicate a fast boot and “0” is pre-defined to indicate a normal boot; the fast boot component 113 may determine whether the first value equals “1” as indicating a fast boot or equals “0” as indicating a normal boot. Responsive to determining that the first value indicates the fast boot, the fast boot component 113 may load a fast boot firmware from the memory device 230 into the embedded volatile memory (e.g., the local memory 119). In some implementations, the fast boot firmware includes boot partition support features that includes peripheral component interconnect express (PCIe) and non-volatile memory express (NVMe) interface functionality. Upon loading a fast boot firmware, the fast boot component 113 may execute the fast boot firmware to enable access to a boot partition of the memory device 230 before the controller 215 has full operational access to the memory device 230, meaning the host system 220 also does not yet have full operational access to the memory device 230. In some implementations, executing the fast boot firmware further initializes the PCIe training of a single PCIe lane at a first data rate, e.g., a GEN1 speed that provides PCIe functionality the soonest possible during the fast boot procedure.

The fast boot component 113 may perform a first training of PCIe lanes of the PCIe link 250 that exists between the host system 120 and the PCIe device 210. Performing the first training of PCIe lanes may use parameters of the fast boot, for example, a second value stored in the register 213 of the PCIe device 210. A first training of PCIe lanes may establish a stable PCIe link 250 and configure the communication parameters to achieve optimal signal integrity and error-free data transmission. The training may involve exchanging information regarding speed capabilities, lane configurations, and supported features between the host system 220 and the PCIe device 210 and adjusting transmission parameters based on the exchanged information. For example, during the training and negotiation processes, the PCIe device 210 may negotiate with the host system 220 to determine the number of PCIe lanes that the link can consist of and the data transfer rate per lane based on the optimal parameters supported by both the host system 220 and the PCIe device 210. In some implementations, the PCIe device 210 and the host system 220 may communicate their capabilities to each other and negotiate to determine, according to the second value stored in the registers 213, the number of lanes that the PCIe link 250 can consist of and the data transfer rate per lane in the PCIe link 250. In some implementations, the PCIe device 210 may send the second value stored in the register 213 to the host system 220, and the host system 220 may adjust the parameter(s) to be compatible with the second value. For example, the second value may include at least one of: a minimum data rate representing a link speed, or a minimum number of PCIe lanes representing a link width. In some implementations, the second value may be pre-defined during the manufacture of the PCIe device 210.

Upon the first training of PCIe lanes, the fast boot component 113 may allow the host system 220 to access first boot data that may be located in the boot partition 235 of the non-volatile memory device 230. The first boot data may be used by the host system 220 for a fast boot from a boot partition 235 of the non-volatile memory device 230. The boot partition 235 may contain only essential files, such as initial program, kernel images, configuration files, executable code, and other data necessary for the system's bootstrapping process. The initial program is responsible for initiating the operating system and facilitating the transfer of control to the kernel or core operating system components. In some implementations, the first boot data may include data for initiating a non-volatile memory express (NVMe) boot of the host system 220 to provide a partial operational state of the operating system on the host system 220. For example, the host system 220 may begin a bootstrap phase, e.g., by executing the boot code to load the boot loader code from the boot partition 235 of the memory device 230 into volatile memory of the host system 220 (e.g., the host memory 219). The host system 220 may execute the boot loader code to load the OS kernel from the boot partition 235 into volatile memory of the host system 220 (e.g., the host memory 219) and execute the OS kernel to initialize boot of the OS (such as Linux®, Window®, or other OS). It enables the host system to transition from the firmware environment to the partial operational state of the operating system. At this point, the partial operational support is provided to the host system 120 for access to the memory device 230.

In some implementations, after the host system 220 has used the first boot data to boot the operating system, the host system 220 may send another reset signal 271 to the PCIe device 210. The reset signal can be similar to the one described above. In some implementations, the fast boot component 113 may determine again whether a first value stored in the register 213 of the PCIe device 210 indicates a fast boot. For example, the fast boot component 113 may determine whether the first value equals “1” indicating a fast boot or determine if the first value equals “0” indicating a normal boot.

Responsive to determining that the first value indicates the normal boot, the fast boot component 113 may load a normal boot firmware from the memory device 230 into the embedded volatile memory (e.g., the local memory 119). Upon loading a normal boot firmware, the fast boot component 113 may execute the normal boot firmware to enable full operational access to the memory device 230, meaning the host system 220 also have full operational access to the memory device 230. In some implementations, executing the normal boot firmware further initializes the PCIe training of multiple PCIe lanes at a second data rate, e.g., a GEN2 speed that provides PCIe functionality during the normal boot procedure.

The fast boot component 113 may perform a second training of PCIe lanes in the PCIe link 250, where the second training of PCIe lanes uses parameters of the normal boot, for example, a third value stored in the register 213 of the PCIe device 210. During the training and negotiation processes, the PCIe device 210 may negotiate with the host system 220 to determine, according to the third value, the number of lanes that the PCIe link 250 can consist of and the data transfer rate per lane in the PCIe link 250. For example, the third value may include a value indicating the maximum number of lanes for a normal boot and/or a value indicating the highest data transfer rate per lane for a normal boot. In some implementations, the PCIe device 210 may send the third value to the host system 220, and the host system 220 may adjust the parameter(s) to be compatible with the third value. For example, the third value may include at least one of: a maximum data rate representing a link speed, or a maximum number of PCIe lanes representing a link width. In some implementations, the third value may be pre-defined during the manufacture of the PCIe device 210.

Upon the second training of PCIe lanes, the host system 220 may access second boot data that is used for a normal boot. The second boot data may be stored in another designated storage area of the non-volatile memory device 230 and may include data to provide a full operational state of the operating system on the host system 220. For example, the host system 220 may begin a bootstrap phase, e.g., by executing the boot code to load the boot loader code from the memory device 230 into volatile memory of the host system 220 (e.g., the host memory 219). The host system 220 may execute the boot loader code to load the OS kernel into embedded volatile memory (e.g., the host memory 219) from the PCIe device 210 and execute the OS kernel to initialize boot of the OS (such as Linux®, Window®, or other OS). It enables the host system to transition from the initial host system boot environment to the full operational state of the operating system (e.g., initializing device drivers, launching system services, and providing the user interface or command line for user interaction). At this point, the OS may take control of the whole PCIe device 210, and the full operational support is provided to the host system 120 for access to the memory device 230. This may mark the completion of the booting process and the operating system is ready to execute user applications and perform computing tasks.

In some implementations, after the host system 220 has performed a normal boot of the operating system, the host system 220 may set to modify the first value of the register 213 so that the first value indicates a fast boot. This can ensure the fast boot will be performed recursively when a power-up event is detected again. In some implementations, the first value may be reset to a default value. In some implementations, the first value may be set as a value that can be changed only when the power supply is on but will be returned to a default value when the power supply is off. As such, the host system 220 can have a fast boot using the non-volatile memory device 230, rather than a traditionally used flash drive included in the PCIe device 210.

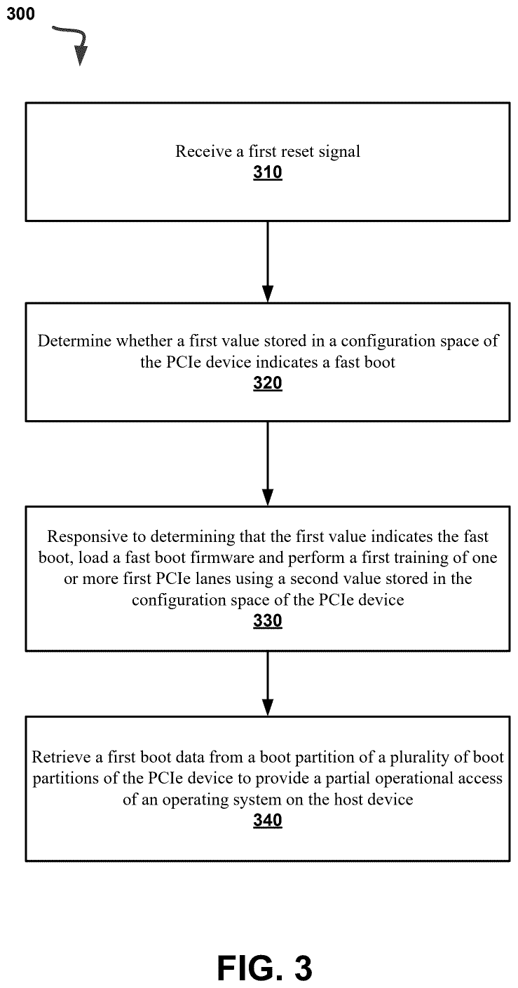

FIGS. 3-5 are flow diagrams of example methods 300, 400, 500 for implementing fast boot on peripheral component interconnect express (PCIe) device, in accordance with some embodiments of the present disclosure. The methods 300, 400, 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 300, 400, 500 are performed by the fast boot component 113 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 3, a host system can determine whether a parameter of a power supply of a host system (e.g., host system 220) satisfies a threshold criterion. In some implementations, the host system can determine whether the parameter of the power supply satisfies a threshold criterion by monitoring the voltage at a power supply terminal in the host system or an interface of the host system, and when the change of the voltage exceeds a certain threshold value or the value of the voltage is below a certain threshold value, the host system determines that the parameter of the power supply satisfies the threshold criterion. Responsive to determining that the parameter of the power supply satisfies the threshold criterion, the host system can send a reset signal to the processing logic in the PCIe device.

At operation 310, the processing logic can receive a reset signal. In some implementations, the reset signal (e.g., PERST) is used to reset and initialize the PCIe device (e.g., PCIe device 210). At operation 320, the processing logic can determine whether a first value stored in a configuration space (e.g., register 213) of the PCIe device indicates a fast boot. In some implementations, the processing logic may determine the first value equaling “1” as indicating a fast boot and/or determine the first value equaling “0” as indicating a normal boot.

At operation 330, responsive to determining that the first value stored in a configuration space of the PCIe device indicates a fast boot, the processing logic may load a fast boot firmware from the memory device, wherein the fast boot firmware is to enable access to a boot partition of the memory device before the processing device has full operational access to the memory device. In some implementations, the processing logic may perform, using the second value stored in the configuration space of the PCIe device, a first training of one or more first PCIe lanes. In some implementations, the processing logic may perform the first training by exchanging information regarding speed capabilities, lane configurations, and supported features between the host system and the PCIe device and adjusting one or more transmission parameters based on the exchanged information. In some implementations, the second value may include at least one of: a first data rate representing a link speed less than a maximum link speed, or a first number of PCIe lanes representing a link width less than a maximum link width.

At operation 340, the processing logic can retrieve a first boot data from a boot partition of the PCIe device to provide a partial operational state of the operating system on the host system. In some implementations, the first boot data may include data for initiating a non-volatile memory express (NVMe) boot of the host system to provide a partial operational state of the operating system on the host system. In some implementations, responsive to receiving a request from the host system, the processing logic retrieves the first boot data from the boot partition of the PCIe device.

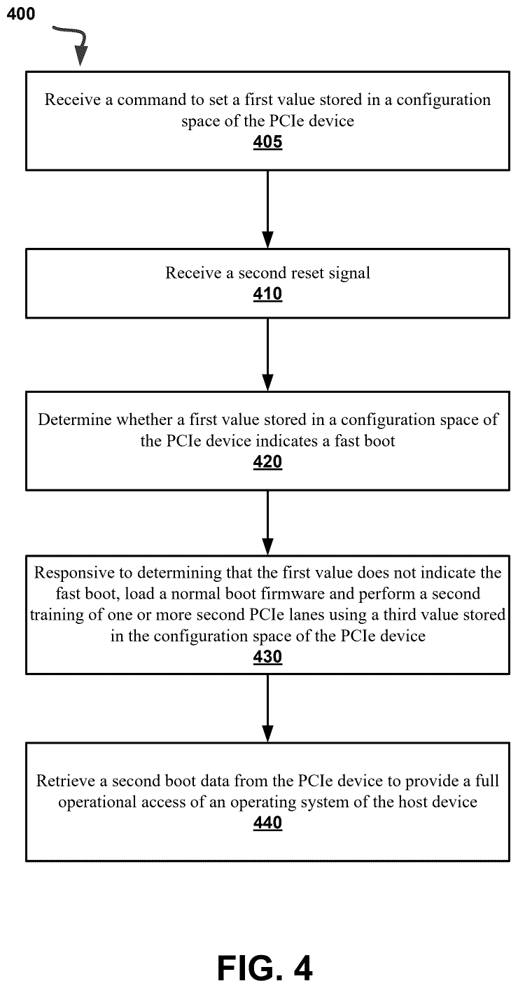

Referring to FIG. 4, at operation 405, the processing logic can receive a command to set a first value stored in a configuration space (e.g., register 213) of the PCIe device. In some implementations, the first value of the first register may be modified to a value indicating a normal boot. In some implementations, the operation 405 is performed after the operation 340.

At operation 410, the processing logic can receive another reset signal, which can be the same as or similar to operation 310. At operation 420, the processing logic can determine whether a first value stored in the configuration space of the PCIe device indicates a fast boot, which can be the same as or similar to operation 320.

At operation 430, responsive to determining that the first value stored in the configuration space of the PCIe device does not indicate a fast boot, the processing logic may load a normal boot firmware from the memory device, wherein the normal boot firmware is to enable the processing device to have full operational access to the memory device. In some implementations, the processing logic may perform, using the third value stored in the configuration space of the PCIe device, a second training of one or more second PCIe lanes. In some implementations, the processing logic may perform the second training by exchanging information regarding speed capabilities, lane configurations, and supported features between the host system and the PCIe device and adjusting one or more transmission parameters based on the exchanged information. In some implementations, the third value may include at least one of: a second data rate representing a maximum link speed, or a second number of PCIe lanes representing a maximum link width.

At operation 440, the processing logic can retrieve a second boot data from the PCIe device to provide a full operational state of the operating system on the host system. In some implementations, the second boot data may include data for initiating a non-volatile memory express (NVMe) boot of the host system to provide a full operational state of the operating system on the host system. In some implementations, after access the second boot data, the processing logic may reset the first value by modifying it to a default value indicating a fast boot.

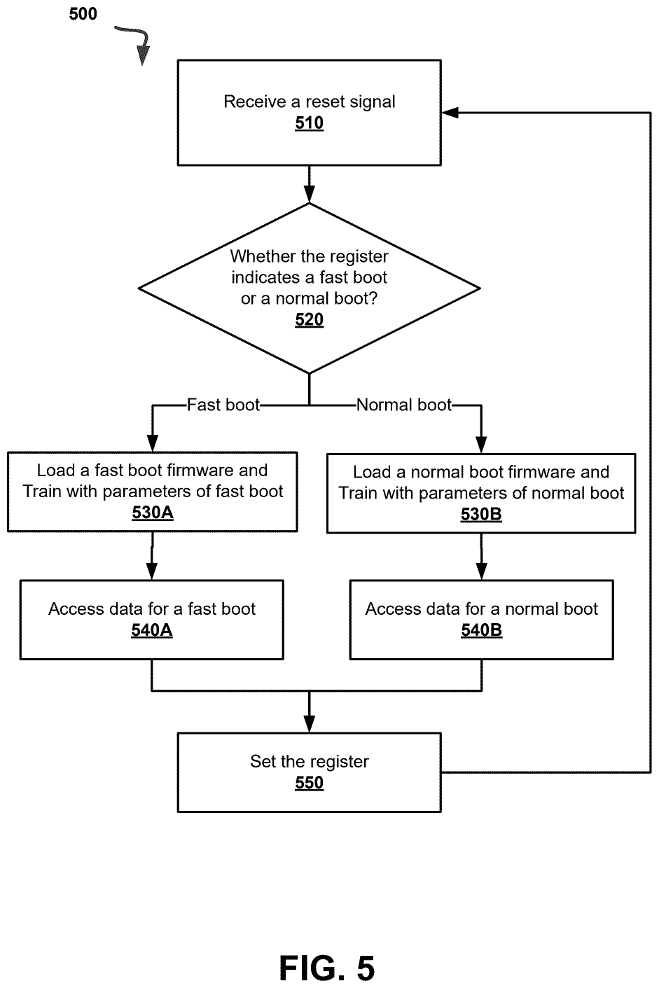

Referring to FIG. 5, at operation 510, the processing logic can receive a reset signal, which can be the same as or similar to operation 310 and/or operation 410. At operation 520, the processing logic can determine whether a first value stored in a configuration space register of the PCIe device indicates a fast boot (or a normal boot), which can be the same as or similar to operation 320 and/or operation 420.

At operation 530A, responsive to determining that that the first value stored in the configuration space register of the PCIe device indicates a fast boot, the processing logic can load a fist boot firmware and perform, using the second value stored in the configuration space register of the PCIe device, a first training of one or more first PCIe lanes, which can be the same as or similar to operation 330. At operation 540A, the processing logic can access data for a fast boot, for example, a first boot data from a boot partition of a plurality of boot partitions of the PCIe device to provide a partial operational state of the operating system on the host system, which can be the same as or similar to operation 340.

At operation 530B, responsive to determining that the first value stored in the configuration space register of the PCIe device indicate a normal boot, the processing logic can perform, using the third value stored in the configuration space register of the PCIe device, a second training of one or more second PCIe lanes, which can be the same as or similar to operation 430. At operation 540B, the processing logic can access data for a normal boot, for example, a second boot data from the PCIe device to provide a full operational state of the operating system on the host system, which can be the same as or similar to operation 440.

At operation 550, the processing logic can set the first value stored in the configuration space register of the PCIe device. In some implementations, the processing logic can set the first value responsive to receiving a command to set the first value, where the command specifies a value, for example, a value indicating a fast boot or a value indicating a normal boot. In some implementations, the processing logic set the first value to a value indicating a fast boot by using a value that can be changed only when the power supply is on but will be returned to a default value when the power supply is off. In some implementations, the processing logic set the first value to a value indicating a fast boot by resetting the first value to a default value indicating a fast boot. After the operation 550, the operation may process back to operation 510.

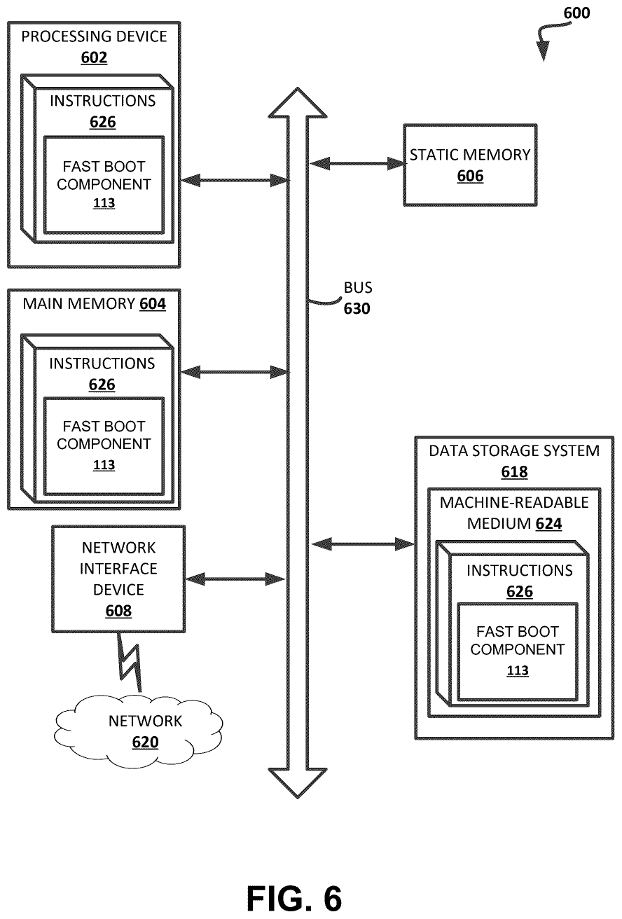

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the fast boot component 113 of FIGS. 1 and 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a fast boot component (e.g., the fast boot component 113 of FIGS. 1 and 2). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving, from a host system connected to the memory device, a first reset signal;
determining whether a first value stored in a configuration space of the memory device indicates a fast boot;
responsive to determining that the first value indicates the fast boot, loading a fast boot firmware from the memory device, wherein the fast boot firmware allows the processing device to access a boot partition of the memory device; and
responsive to receiving a request from the host system, retrieving boot data from the boot partition.

2. The system of claim 1, wherein the operations further comprise:
performing, using a second value stored in the configuration space of the memory device, a first training of one or more first connection lanes between the memory device and the host system.

3. The system of claim 2, wherein the second value indicates at least one of: a first data rate representing a link speed less than a maximum link speed, or a first number of connection lanes representing a link width less than a maximum link width.

4. The system of claim 1, wherein the operations further comprise:
responsive to determining that the first value does not indicate the fast boot, loading a normal boot firmware from the memory device, wherein the normal boot firmware allows the processing device to have full operational access to the memory device; and
performing, using a third value stored in the configuration space of the memory device, a second training of one or more second connection lanes between the memory device and the host system, wherein the third value indicates at least one of: a second data rate representing a maximum link speed, or a second number of connection lanes representing a maximum link width.

5. The system of claim 1, wherein the operations further comprise:
modifying, in a configuration space of the memory device, the first value to indicate a normal boot;
receiving a second reset signal;
determining whether the modified first value indicates a normal boot;
responsive to determining that the modified first value indicates the normal boot, loading a normal boot firmware from the memory device, wherein the normal boot firmware allows the processing device to have full operational access to the memory device; and
performing, using one or more values representing a maximum link speed and a maximum link width, a second training of one or more second connection lanes.

6. The system of claim 5, wherein the operations further comprise:
modifying the modified first value to a default value indicating the fast boot.

7. The system of claim 1, wherein the host system is connected to the memory device via a peripheral component interconnect express (PCIe) link, and wherein the fast boot firmware comprises boot partition support features that includes peripheral component interconnect express (PCIe) interface functionality.

8. The system of claim 1, wherein the memory device comprises a non-volatile memory.

9. A method comprising:
receiving, by a processing device, from a host system connected to a memory device, a first reset signal;
determining whether a first value stored in a configuration space of the memory device indicates a fast boot;
responsive to determining that the first value indicates the fast boot, loading a fast boot firmware from the memory device, wherein the fast boot firmware allows the processing device to access a boot partition of the memory device; and
responsive to receiving a request from the host system, retrieving boot data from the boot partition.

10. The method of claim 9, further comprising:
performing, using a second value stored in the configuration space of the memory device, a first training of one or more first connection lanes between the memory device and the host system.

11. The method of claim 10, wherein the second value indicates at least one of: a first data rate representing a link speed less than a maximum link speed, or a first number of connection lanes representing a link width less than a maximum link width.

12. The method of claim 9, further comprising:
modifying, in a configuration space of the memory device, the first value to indicate a normal boot;
receiving a second reset signal;
determining whether the modified first value indicates a normal boot;
responsive to determining that the modified first value indicates the normal boot, loading a normal boot firmware from the memory device, wherein the normal boot firmware allows the processing device to have full operational access to the memory device; and
performing, using one or more values representing a maximum link speed and a maximum link width, a second training of one or more second connection lanes.

13. The method of claim 12, further comprising:
modifying the modified first value to a default value indicating the fast boot.

14. The method of claim 9, wherein the host system is connected to the memory device via a peripheral component interconnect express (PCIe) link, and wherein the fast boot firmware comprises boot partition support features that includes peripheral component interconnect express (PCIe) interface functionality.

15. The method of claim 9, wherein the memory device comprises a non-volatile memory.

16. A non-transitory computer-readable storage medium comprising instructions that, when executed by a processing device, cause the processing device to perform operations comprising:
receiving, from a host system connected to a memory device, a first reset signal;
determining whether a first value stored in a configuration space of the memory device indicates a fast boot;
responsive to determining that the first value indicates the fast boot, loading a fast boot firmware from the memory device, wherein the fast boot firmware allows the processing device to access a boot partition of the memory device; and
responsive to receiving a request from the host system, retrieving boot data from the boot partition.

17. The non-transitory computer-readable storage medium of claim 16, wherein the operations further comprise:
performing, using a second value stored in the configuration space of the memory device, a first training of one or more first connection lanes between the memory device and the host system.

18. The non-transitory computer-readable storage medium of claim 17, wherein the second value indicates at least one of: a first data rate representing a link speed less than a maximum link speed, or a first number of connection lanes representing a link width less than a maximum link width.

19. The non-transitory computer-readable storage medium of claim 16, wherein the operations further comprise:
modifying, in a configuration space of the memory device, the first value to indicate a normal boot;
receiving a second reset signal;
determining whether the modified first value indicates a normal boot;
responsive to determining that the modified first value indicates the normal boot, loading a normal boot firmware from the memory device, wherein the normal boot firmware allows the processing device to have full operational access to the memory device; and
performing, using one or more values representing a maximum link speed and a maximum link width, a second training of one or more second connection lanes.

20. The non-transitory computer-readable storage medium of claim 19, wherein the operations further comprise:
modifying the modified first value to a default value indicating the fast boot.
